(19) United States
(12) Patent Application Publication
(10) Pub. No.: US 2015/0233066 A1
(43) Pub. Date: Aug. 20, 2015

(54) REINFORCEMENT FOR A CONCRETE TILE

(71) Applicant: André OUELLET, (US)

(72) Inventor: André Ouellet, Sherbrooke (CA)

(21) Appl. No.: 14/428,028

(22) PCT Filed: Sep. 13, 2013
(86) PCT No.: PCT/CA2013/000778

§ 371 Date: Mar. 13, 2015

Related U.S. Application Data
(60) Provisional application No. 61/700,909, filed on Sep. 14, 2012.

(51) Int. Cl. E01C 11/18; B28B 7/00

(52) U.S. Cl. CPC E01C 11/18; B28B 7/00

(57) ABSTRACT

A reinforcement for concrete tiles comprising an element formed in a flat elongated shape having a top and bottom surface, a plurality of scales extending from the top surface at an angle thereto, and wherein the angle of a number of the scales are formed in an opposite direction from the remaining scales, and adapted such that when in place within a concrete tile the element cannot slip out therefrom, and adapted such that when the tile experiences a bending force the element creates a compressive force opposite the bending force to thereby prevent the tile from bending and breaking.

### FIELD OF THE INVENTION

The present invention relates generally to concrete elements but more particularly to a reinforcement for a concrete tile.

### BACKGROUND OF THE INVENTION

Concrete tiles used as a decorative element for pavement, patios, walkways, etc are quite popular. Typically, no steel reinforcement are within the concrete as the products are placed directly on the ground. Sometimes, when they need to put concrete over a structure, manufacturer will decide to increase thickness of the product or, they use a steel reinforcement grid placed within. Generally midway or the lower third of the thickness of the concrete. There is also a technique known as ferro-cement which combines steel rebars with metal mesh such as chicken wire mesh in order to create a stronger concrete. Typically, whether in the case of reinforced concrete or ferro-cement, careful positioning of the steel armature as well as ensuring that the armature does not move during the compacting and vibrating of the concrete makes the process rather difficult to achieve in an optimal way and only highly trained and skilled artisans can produce a consistently good piece of decorative concrete.

### SUMMARY OF THE INVENTION

In view of the foregoing disadvantages inherent in the known devices now present in the prior art, the present invention, which will be described subsequently in greater detail, is to provide objects and advantages which are:

To provide for a way to install a reinforcement for a concrete tile which is easy to position while providing an excellent means of reinforcement.

In order to do so, the invention consists of a reinforcement for concrete tiles comprising an element formed in a flat elongated shape having a top and bottom surface, a plurality of scales extending from the top surface at an angle thereto, and wherein the angle of a number of the scales are formed in an opposite direction from the remaining scales, and adapted such that when in place within a concrete tile the element cannot slip out therefrom, and adapted such that when the tile experiences a bending force the element creates a compressive force opposite the bending force to thereby prevent the tile from bending and breaking.

The reinforcement has its scales; scales are formed in two parallel rows in a direction along the elongated length of the element.

The number of the scales that are formed in the opposite direction is half of the total of the plurality of scales.

The elongated shape of the element is rectangular.

The element and the plurality of scales are formed from a material chosen from a list of materials comprising non-corroding metals, polymers, and composites. Preferably, the plurality of scales is formed from galvanized steel.

An apparatus for making an improved reinforced concrete tile formed from concrete and including at least one reinforcing element placed within an interior section thereof that is formed in a flat elongated shape having a top and bottom surface, a plurality of scales extending from the top surface at an angle thereto, and wherein the angle of a number of the scales are formed in an opposite direction from the remaining scales, wherein the apparatus for making the reinforced concrete tile comprises a sub-structure includes a pair of straight beams adapted to be placed in a spaced and parallel configuration from one another a distance adapted to hold a chosen mold member thereon. A mold member having a bottom surface and four walls forming a volume and shape chosen to form the concrete tile, and including a plurality of peg members placed within the volume of the mold member such that the at least one reinforcing element is held in a chosen position, and adapted such that when concrete is poured into the mold member the at least one reinforcing element does not move, and when the concrete is set the at least one reinforcing element is in desired permanent positions.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1a-c Isometric, top, and end views, respectively, of the invention.

FIG. 2 Bottom view of the invention embedded in a tile.

FIG. 3 Side cutaway view along line AA of the invention embedded in a tile installed on a sub-structure.

FIG. 4 Cutaway side view of a mold with pegs.

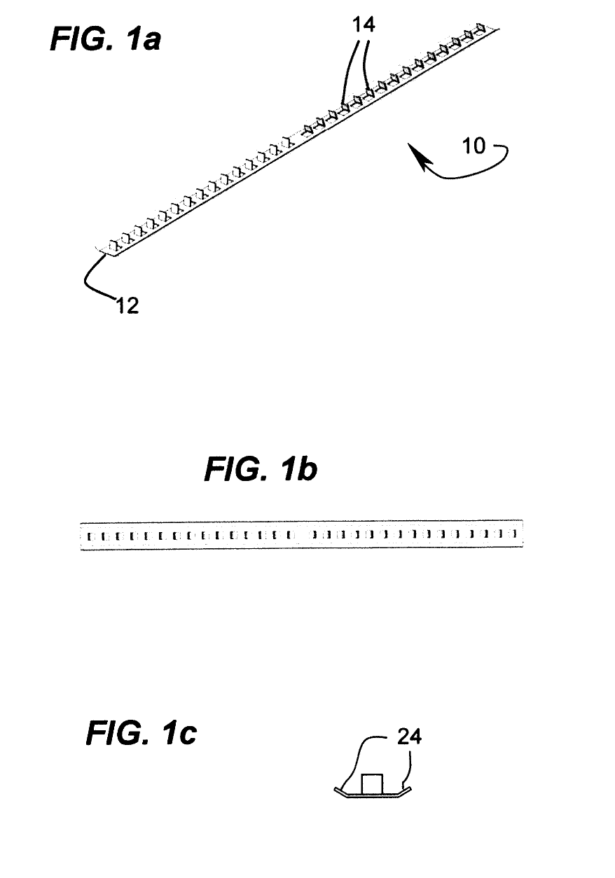

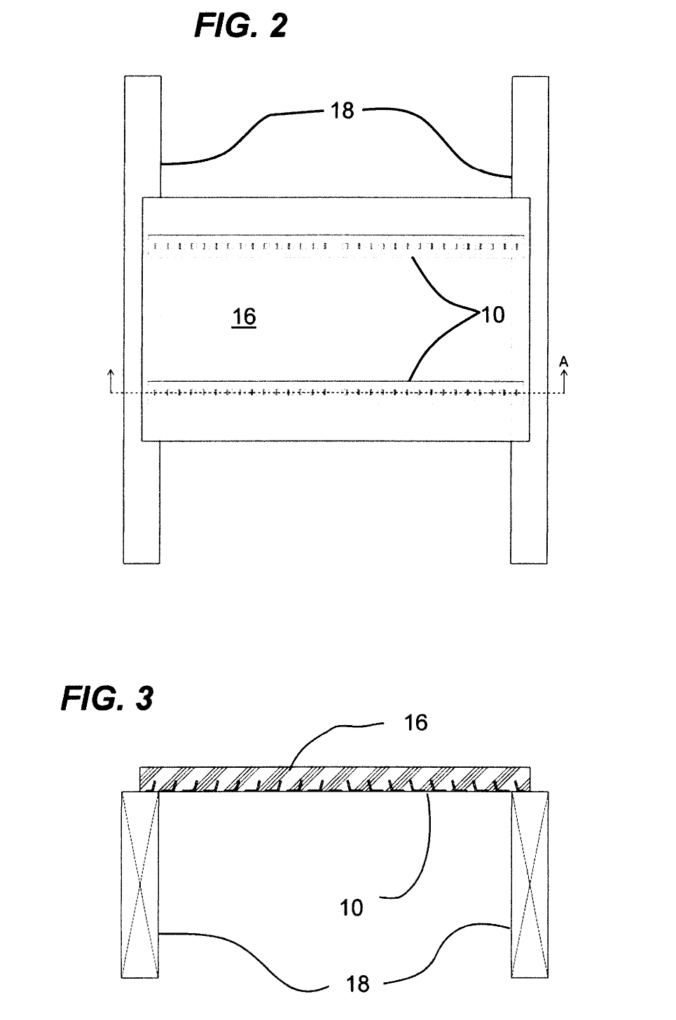

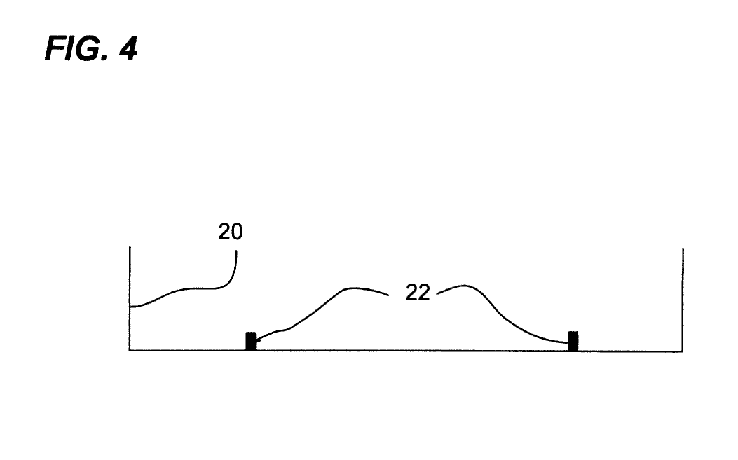

### DETAILED DESCRIPTION OF THE PREFERRED EMBODIMENT

A reinforcement element (10) for a concrete tile (16) is formed of a flat and rectangular element (12) that is placed on the underside surface a tile (16). The reinforcing element (12) has a plurality of angled scales (14) which are deeply embedded into the concrete of the tile (16) so as to provide increased adherence to the tile (16). The reinforcement element (12) is made of a strong material such as galvanized steel, or such metal treated against corrosion, or non-corroding metal or any material suitable for the task such as polymers and existing or yet to be invented composite material. The main purpose here being to provide a way to prevent the tile (10) from being overly deformed to the point of breaking. With this reinforcement element (12), no mesh or rebars are required.

The scales (14) are angled in such a way that half of the scales (14) are slanted in one direction and the other half of the scales (14) are slanted in the opposite direction, and all the scales (14) are slanted towards the center of the reinforcement element (10) so that once the concrete is cured, it is impossible for the reinforcement element (10) to slide out. Also, the opposing slant of the scales (14) creates a compressive force which keeps the tile (16) from bending. The tile (16) can be laid on a sub-structure (18) such as wooden beam or studs.

To further prevent the bending of the tile, the reinforcement element (10) has a pair of parallel folds (24) running along both sides of its length.

Typically, the reinforcement element (12) is laid first at the bottom of a mold (20) and a dry mix is poured on top of it. Simple pegs (22) can act as positioning means for the reinforcement element (12). As many as 4 pegs per reinforcement elements (12) can be put. More than one reinforcement element (12) can be placed inside the mold (20). When the cement mix has sufficiently hardened, the tile (16) can be removed from the reusable mold (20). For a liquid mix (wet cast), typically, the reinforcement element are put on top, after the concrete has been poured in the reusable mold.

As to a further discussion of the manner of usage and operation of the present invention, the same should be apparent from the above description. Accordingly, no further discussion relating to the manner of usage and operation will be provided. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A reinforcement for concrete tiles, comprising an element formed in a flat elongated shape having a top and bottom surface; a plurality of scales extending from said top surface at an angle thereto, and wherein the angle of a number of said scales are formed in an opposite direction from the remaining scales, and adapted such that when in place within a concrete tile said element cannot slip out therefrom, and adapted such that when said tile experiences a bending force said element creates a compressive force opposite said bending force to thereby prevent the tile from bending and breaking.

2. The reinforcement of claim 1, wherein said plurality of scales are formed in two parallel rows in a direction along the elongated length of said element.

3. The reinforcement of claim 1, wherein said number of said scales that are formed in said opposite direction is half of the total of said plurality of scales.

4. The reinforcement of claim 1, wherein said scales are all slanted towards the center of the reinforcement element.

5. The reinforcement of claim 1, wherein said elongated shape of said element is rectangular.

6. The reinforcement of claim 1, wherein said element and said plurality of scales are formed from a material chosen from a list of materials comprising non-corroding metals, polymers, and composites.

7. The reinforcement of claim 1 wherein a pair of parallel folds are running along both sides of the length of the reinforcement.

8. The reinforcement of claim 6, wherein said element and said plurality of scales are formed from galvanized steel.

9. An improved reinforced concrete tile comprising a tile member formed from concrete; and at least one reinforcing element placed within an interior section thereof, said at least one reinforcing element being formed in a flat elongated shape having a top and bottom surface, a plurality of scales extending from said top surface at an angle thereto, and wherein the angle of a number of said scales are formed in an opposite direction from the remaining scales, and adapted such that when in place within said concrete tile said reinforcing element cannot slip out therefrom, and adapted such that when said tile experiences a bending force said reinforcing element creates a compressive force opposite said bending force to thereby prevent the tile from bending and breaking.

10. The reinforced concrete tile of claim 9, wherein said plurality of scales are formed in two parallel rows in a direction along the elongated length of said reinforcing element.

11. The reinforced concrete tile of claim 9, wherein said number of said scales that are formed in said opposite direction is half of the total of said plurality of scales.

12. The reinforced concrete tile of claim 9, wherein said scales are all slanted towards the center of the reinforcement element.

13. The reinforced concrete tile of claim 9, wherein said elongated shape of said reinforcing element is rectangular.

14. The reinforced concrete tile of claim 9, wherein said reinforcing element and said plurality of scales are formed from a material chosen from a list of materials comprising non-corroding metals, polymers, and composites.

15. The reinforcement of claim 9 wherein a pair of parallel folds are running along both sides of the length of the reinforcement.

16. The reinforced concrete tile of claim 14, wherein said reinforcing element and said plurality of scales are formed from galvanized steel.

17. An apparatus for making an improved reinforced concrete tile formed from concrete and including at least one reinforcing element placed within an interior section thereof that is formed in a flat elongated shape having a top and bottom surface, a plurality of scales extending from said top surface at an angle thereto, and wherein the angle of a number of said scales are formed in an opposite direction from the remaining scales, wherein said apparatus for making said reinforced concrete tile comprises a sub-structure includes a pair of straight beams adapted to be placed in a spaced and parallel configuration from one another a distance adapted to hold a chosen mold member thereon; a mold member having a bottom surface and four walls forming a volume and shape chosen to form said concrete tile, and including a plurality of peg members placed within said volume of said mold member such that said at least one reinforcing element is held in a chosen position, and adapted such that when concrete is poured into said mold member said at least one reinforcing element does not move, and when said concrete is set said at least one reinforcing element is in desired permanent positions.

18. The reinforced concrete tile of claim 17, wherein there are four peg members adapted to hold one reinforcing element in place.

19. The reinforced concrete tile of claim 17, wherein there are eight peg members adapted to hold two reinforcing element in place.

20. The reinforced concrete tile of claim 17, wherein said sub-structure and said mold member are formed from a material chosen from a list of materials comprising wood, plastic, metal, and composite materials.
